(19) United States
(12) Patent Application Publication
(10) Pub. No.: US 2017/0339469 A1
(43) Pub. Date: Nov. 23, 2017

(54) EFFICIENT DISTRIBUTION OF REAL-TIME AND LIVE STREAMING 360 SPHERICAL VIDEO

(71) Applicant: Arjun Trikannad, Irvine, CA (US)

(72) Inventor: Arjun Trikannad, Irvine, CA (US)

(21) Appl. No.: 15/603,089

(22) Filed: May 23, 2017

Related U.S. Application Data
(60) Provisional application No. 62/340,460, filed on May 23, 2016.

(51) Int. Cl. H04N 21/61; H04N 21/81; H04N 21/6379; H04N 21/6336; H04N 21/44; H04N 21/858; H04N 21/233

(52) U.S. Cl. CPC H04N 21/6125; H04N 21/8586; H04N 21/816; H04N 21/233; H04N 21/6336; H04N 21/44; H04N 21/6379

(57) ABSTRACT

A system for providing 360 video is presented. It includes a video encoder for encoding video data with metadata which includes a manifest. The manifest specifies how to position each video in relation to others during playback. A communication apparatus transmits video data feeds from the video encoder, each video data feed being streamed over one or more uniform resource locators (URLs). The video data feeds are decoded according to the metadata to produce spherical video, the manifest carrying information on how to position video produced from the plurality of video data feeds.

### CROSS-REFERENCE TO RELATED APPLICATION(S)

The present application claims priority to U.S. Provisional Patent Application No. 62/340,460 filed on May 23, 2016, entitled “Efficient Distribution of Real-Time and Live Streaming 360 Spherical Video” the entire disclosure of which is incorporated by reference herein.

### BACKGROUND OF THE INVENTION

### Description of Related Art

A 360° spherical video, also known as 360 Videos, 360 degree videos, immersive videos, or spherical videos are video recordings displaying a real-world panorama. To create a 360 spherical video, the view in every direction is recorded or captured at the same time, using an omnidirectional camera or a collection of cameras. During playback, the viewer has control of the viewing direction, a form of virtual reality. On iOS and Android mobile devices, the viewing angle (or field of view) of a 360 Video is changed by dragging a finger across the screen or by navigating with the device in physical space, i.e., moving the device left or right or up or down).

Using current technology, each camera in the rig captures its own separate video and audio resulting in each having its own field of view. The separate videos or fields of view are synchronized in time and then processed frame by frame. Each frame from each separate video are then “stitched” together by finding matching parts of the edges within each frame within the video. The matched parts are aligned on top of one another and then the edges are blended to remove the appearance of the seams between each video frame. This process is repeated for each frame within the video and results in a “stitched” 360 Video.

The audio from each camera is mixed down to a stereo signal or converted into ambisonics before reintegrating with the “stitched” 360 Video. Once the video is stitched, it is encoded for internet delivery. This encoding typically will be in the form of Adaptive BitRate (“ABR”) wherein multiple qualities are created and made available to viewers. The viewer's App then selects the highest quality based on hardware capabilities and available bandwidth. ABR is known in the art as a standard way of internet video is creation.

Using current technology, 360 Videos are created by capturing video using a video rig comprising multiple cameras or an omnidirectional camera. Each camera captures individual videos. The videos are analyzed and arranged by matching edges. The separate videos are then “stitched” together to form 360 Video. The audio is either combined into a single stereo feed or encoded to comply with ambisonics for virtual surround sound rendering during playback within the App. The 360 Video is encoded into multiple profiles for streaming leveraging Adaptive Bitrate encoding methodologies. The 360 Video stream is sent to a Content Delivery Network (“CDN”) for mass distribution. Finally, Playback devices consume the stream after acquiring it over one or more networks.

However, current technology has many drawbacks. First, the final stitched 360 Video typically results in extremely high resolution requiring it to be down-encoded for mass distribution. Each camera can capture 1080p (1K) video (even higher sometimes). Some rigs can contain up to 10 cameras (or more). Given some video frame overlap, the resulting final stitched 360 Video could theoretically near 8K in resolution. For example, Netflix HD (1080p) video requires 5 Mbps of bandwidth. An 8K video would generally require 40 Mbps often not available to playback devices, especially those relying on wireless networks.

Second, viewer quality suffers because of bandwidth limitations or device graphics processing unit (“GPU”) limitations and must be encoded at qualities much lower than HD for scaled distribution and consumption. Higher qualities may be achieved but generally not with commodity hardware readily available to the viewer under current technology.

Third, if ambisonics are not leveraged, the consumer experience will typically have either stereo or surround sound facing a fixed front position. This audio does not change with the field of view, resulting in a diminished experience.

Based on the foregoing, there is a need in the art for a system for creating 360 Videos that results in smaller file sizes, that do not consume exorbitant amounts of bandwidth, and that maintains stereoscopic sound. Such a need has heretofore remained unsatisfied in the art.

### SUMMARY

In one embodiment, a system is presented for providing 360 video. The system includes a video encoder for encoding video data with metadata including a manifest. A number of video data feeds from the video encoder may be transmitted, each video data feed being streamed over one or more uniform resource locators (URLs). The video data feeds can be decoded according to the metadata to produce spherical video, the manifest carrying information on how to position video produced from the plurality of video data feeds.

In another embodiment, an apparatus is presented for receiving 360 video. It includes a headset for viewing video and a controller for coordinating video views with headset movement. The controller includes a decoder. The controller may receive streamed video data feeds from a number of URLs and the decoder can decode metadata contained within the streamed video data feeds in order to enable the headset to produce 360 video from stitched together video.

In another embodiment, a method of transmitting 360 video is presented which includes receiving video data from cameras; determining spherical video with the video data from the cameras; documenting the spherical video by creating metadata including a manifest carrying information on how to position video produced from a video data feeds resulting from the video data from the cameras; and streaming the video data feeds including the metadata for reconstruction of the spherical video.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart presenting one embodiment of the present disclosure.

FIG. 2 is a diagram illustrating a system according to an exemplary embodiment of the present disclosure.

FIG. 3 is a diagram illustrating playback of video/audio according to some embodiments of the present disclosure.

### DETAILED DESCRIPTION OF PREFERRED EMBODIMENTS

The present disclosure relates to the field of video capturing, encoding, transmission, and playback. Specifically, the present disclosure relates to capturing, encoding, transmitting, and playing 360-degree spherical videos.

The following is a glossary of terms as used and contained herein:

360 Video—a 360 spherical video also known as 360 Videos, 360 degree videos, or immersive videos, refers to exemplary video recordings of a portraying a real-world panorama, where the view in every direction is recorded at the same time using an omnidirectional camera or a collection of cameras;

Adaptive bitrate (“ABR”) streaming—ABR Streaming refers to leveraging hypertext transfer protocol (“HTTP”) Live Streaming (“HLS”) and/or Dynamic Adaptive Streaming over HTTP (“DASH”) specifications for the purpose of delivering video and audio content to users/viewers over the internet. ABR is also referred to as Dynamic Streaming;

Ambisonics—refers to an exemplary full-sphere surround sound technique: in addition to the horizontal plane, it covers sound sources above and below the listener. Unlike other multi-channel surround formats, e.g., 5.1 or 7.1 surround, its transmission channels do not carry distinct or specific speaker signals but rather audio channels that are mapped by the App on the Playback Device to render where to place a specific audio channel in the full-sphere;

App—refers to an exemplary application or computer-implemented program;

Audio/Video Synchronization—refers to ensuring the audio matches the video perfectly and is typically not a challenge when simply playing video in original format captured from a camera. Synchronization issues occur once audio is separated from the video and later reintegrated after processing;

Black Screen—refers to an exemplary area within a 360 Video wherein video is missing. Black Screen manifests when the viewer faces a particular field of view but the video stream has not yet buffered. This may happen if the stream is not already running and the viewer head tracks very quickly to that stopped video stream. For example, a black screen may occur in connection with the user quickly turning 180° to see what is behind him/her and the video stream for that view has not already been running;

Buffer—refers to an exemplary portion of video to be acquired before it is displayed on the view portal. This results in a small delay in time between the start of the stream and the playback within the view portal;

Device Application (App)—refers to exemplary software or an application that is used to consume 360 Video. This App runs on the playback device.

Encoder—refers to an exemplary device that connects to a video source (direct from a video camera or a digital video file on disk) and encodes the video into another format and/or codec. FFMPEG, Elemental, Ateme, and Cisco are examples of encoding technologies currently available in the art;

Field of View—refers to the exemplary perspective being displayed within the view portal based on the direction the viewer is facing. A 360 Video originally recorded with 10 cameras will have 10 frames of view;

Frame—refers to an exemplary film frame or video frame and is one of the many still images that compose the complete moving picture;

Frame Rate—refers to the exemplary rate at which video frames are displayed to a viewer and are generally measured in Frames Per Second (“FPS”);

Head Tracking—refers to the exemplary function of determining the field of view and is typically available on playback devices that comprise a gyroscope;

Image—refers to exemplary images that may be two-dimensional, such as a photograph or screen display. Images may be captured by optical devices —such as cameras, mirrors, lenses, etc;

Manifest—refers to an exemplary text file that contains Uniform Resource Locators (“URLs”) to the streams available to the Device Application. The manifest is typically found in video streaming technologies such as HLS or DASH;

Playback Device—an exemplary device on which 360 Video is reproduced for viewing. Playback Devices may comprise computers, desktop computers, laptop computers, tablet devices such as an iPad, Surface, or pixel, mobile devices such as an iPhone or Galaxy, or Virtual Reality (“VR”) Devices such as an Oculus Rift or Google Cardboard;

Position ID—refers to an exemplary identifier that dictates where to place a video (or field of view) in a 360 Video. Position IDs are used to establish the positional relationship between multiple videos. For example, if a 360 Video is made up of 10 separately recorded videos, there will be 10 Position IDs, each containing location information or spatial metadata for each of the 10 fields of view. The Position ID is used to properly position and align each video to create the 360 Video experience;

Profile—refers to an exemplary description of quality and streaming bitrate that informs the Device Application as to how to render the video to the viewer. A manifest may contain multiple profiles and/or qualities from which the Device Application may select;

Quality—refers to the exemplary quality of video the viewer sees. Additionally, quality may refer to the exemplary resolution in which the video is encoded. For example, Standard Definition comprises a resolution of 640 pixels wide by 480 pixels high. By contrast, High Definition 720p comprises a resolution of 1280 pixels wide by 720 pixels high. High Definition 1080p comprises a resolution of 1920 pixels wide by 1080 pixels high;

Rig—Refers to an exemplary camera system that captures 360 Video;

Spatial Metadata—refers to exemplary data or information describing the direction a camera or microphone is facing in physical space. Spatial Metadata may be summarized or contained in a Position ID. Spatial Metadata is to be used to correctly reassemble separately recorded video and audio;

Stitching—refers to an exemplary process by which edges of distinct video frames are blended together to eliminate the seams. Stitching involves matching patterns within two or more video frames, lining up those video frames so that they overlap at the image match and then blended into a single frame output;

View Portal—refers to an exemplary display device's screen. A view portal may be a screen on a mobile phone, tablet, computer (desktop or laptop), television, or VR device;

Virtual Surround Stereo Sound—refers to an exemplary stereo signal (two audio channels; one left, one right) that gives the viewer the perception that sound is coming from all directions similar to that of a 5.1 or 7.1 surround system. To achieve, it is necessary to devise some means of tricking the human auditory system into thinking that a sound is coming from somewhere that it is not;

Virtual Reality (“VR”)—refers to an exemplary computer technology that replicates an environment, real or imagined, and simulates a user's physical presence in that environment.

The present disclosure pertains to a 360 Video system wherein each camera/audio device in the 360 video system sends a video/audio feed (e.g., High-Definition Multimedia Interface (HDMI)) to a video/audio encoder. Each feed is sent with metadata and the feeds are combined by the video/audio encoder to enable composite video formation through contribution by the separate video feeds.

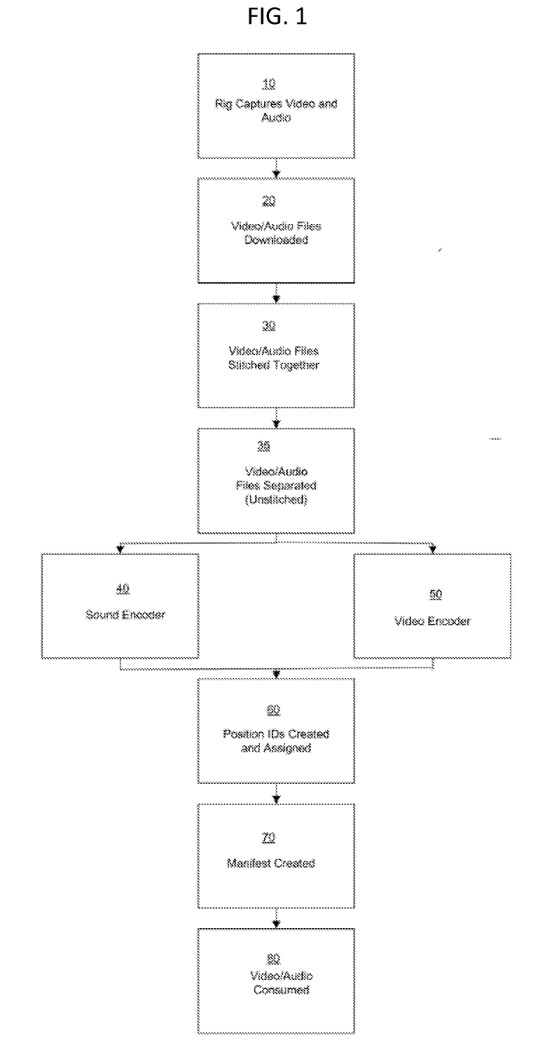

Embodiments of the present invention and their advantages may be understood by referring to FIG. 1 which shows a flowchart according to one embodiment of the present disclosure.

In an exemplary embodiment of the present disclosure, as provided in connection with the video/audio encoder (not shown), stitched 360 Video, formed from separate feeds, of respective camera/audio devices, with a goal of later presenting composite video from the separate feeds having edges that are blended from one or more feeds so as to reduce the number of artifacts among other things. In one embodiment, each audio track corresponding to the individual videos are encoded separately with spatial metadata. For example, if 10 cameras are used in a rig, the audio captured from each camera will have different audio parameters. Each audio signal will also have different special metadata describing the direction of the microphone while recording. Each of the 10 audio recordings are encoded with spatial metadata to create a single stereo auto channel for each of the 10 audio recordings. In another embodiment, a Virtual Surround Sound Encoder is used to encode the audio tracks, wherein each audio channel will be encoded with spatial metadata, resulting is separate stereo audio track created for each separate video.

In another exemplary embodiment of the present disclosure, Position IDs are created and assigned. In one embodiment, the Position IDs identify where, in physical space and direction, the video camera was facing during capture. The Position IDs may be used to determine where to place each individual video in a 360 Video.

In another exemplary embodiment of the present disclosure, relating to video/audio playback, custom manifests are created. In one embodiment, the manifests contain URLs for each field of view. In another embodiment, the manifests may comprise Position IDs or spatial metadata. The manifests may be used by the device application to specify how to position each video in relation to the others during playback.

In another exemplary embodiment of the present disclosure, the videos are encoded using adaptive bit rate (ABR) encoding. In one embodiment, each separated video having a distinct virtual surround stereo track and video Position ID, is encoded into a distinct ABR video stream. For example, encoding a 10-camera rig may result in 10 distinct ABR video streams.

In another exemplary embodiment of the present disclosure, in connection with playback, a device application arranges the video. In one embodiment, the device application may parse the manifest to locate the streaming URL and the Position IDs for each separate video stream. The device application aligns and arranges the separate video streams into a single 360 Spherical Video. Since the videos were pre-stitched and subsequently cut and separated prior to encoding, these video streams already contain the blending necessary to present seamless edges by aligning their respective edges appropriately. This eliminates the need for stitching within the playback device or device application. Utilizing the present disclosure, only video arrangement is required and is possible using the Position IDs.

In another exemplary embodiment of the present disclosure, only the URLs required to provide the desired view are consumed. In one embodiment, separate video streams are made available to viewers. In such an embodiment, the device application retains the flexibility to specify which video streams to consume based on the viewer's field of view. In another embodiment, the application may consume all videos and prioritize the high-quality streams for the viewer's field of view while consuming lower quality streams needed for video streams not within the viewer's field of view. In such an embodiment, the application maximizes usage of the available bandwidth while delivering the highest possible resolution to the viewer.

In another exemplary embodiment of the present disclosure, the audio tracks are added to the viewer's experience. In one embodiment, each separate video has an associated virtual surround stereo audio track. As the viewer's head tracks movement, the field of view changes the video displayed. The device application mixes only the corresponding audio tracks that are being displayed in the view portal. In another embodiment, when a video stream is no longer being displayed within the view portal, the audio for that video is mixed down so the audio for all other fields of view are not perceived by the viewer. In such an embodiment, the viewer only hears the audio corresponding to the video being displayed within the view portal.

In another exemplary embodiment of the present disclosure and with reference to FIG. 1, in step 10, a rig comprising a plurality of cameras records video and audio.

In another exemplary embodiment of the present disclosure, and with reference to FIG. 1, in step 20, each file comprising audio and video files is downloaded from the rig.

In another exemplary embodiment of the present disclosure, and with reference to FIG. 1, in step 30, the video files from the plurality of cameras is stitched together to create a 360 degree video. In one embodiment, each frame from each separate video is stitched together by finding matching parts of the edges within each frame within the video. The matched parts are aligned on top of one another and the edges are blended to remove the appearance of the seams between each video frame. This process may be repeated for each frame within the video. In another embodiment, the audio from each camera is mixed down to a stereo signal or converted into ambisonics before being reintegrating with the stitched 360 Video.

In step 35, the stitched 360 video or stitched 360 video with audio is separated (unstitched) to facilitate the creation of video to be carried by streaming individual data feeds. The separating/separation may be carried out in a variety of ways. For instance, one or more frames of video (for a video perspective) captured by a single camera may be separated from the 360 video for realization through an individual data feed such that there is a one-to-one relationship between a video perspective and an encoded feed. This step may also include separating audio from the video whether ambisonic audio, stereo or otherwise to facilitate the creation of audio to be carried by streaming individual data feeds.

In another exemplary embodiment of the present disclosure and with reference to FIG. 1, in step 38 video and sound files, representing separated (unstitched) video and audio files are encoded with data to facilitate the recreation (re-stitching) of 360 video. In one embodiment, all separate audio tracks captured by the rig comprising a plurality of cameras, are encoded with spatial metadata. Step 38 includes sound (audio) encoding step 40, video encoding step 50. Position ID creation and assignment and manifest creation 70 (explained herein). In another embodiment, each audio signal may have different spatial metadata relating to the direction of the microphone while recording. In another embodiment, the audio tracks are encoded using a virtual surround sound encoder, resulting a single stereo audio channel.

In another exemplary embodiment of the present disclosure and with reference to FIG. 1, in step 60, Position IDs are created and assigned. In one embodiment, Position IDs are created from the spatial metadata from each camera and microphone. In such an embodiment, the Position IDs may be used to identify the spatial orientation of the capturing camera and microphone. In another embodiment, each video is assigned a unique Position ID. In such an embodiment, the Position IDs may be used by the playback device to determined where to place a particular video within a 360 Video.

In another exemplary embodiment of the present disclosure and with reference to FIG. 1, in step 70, manifests are created. In one embodiment, a custom manifest is created for each video file. In one embodiment, the manifest may comprise URLs for each field of view. In another embodiment, the manifest may comprise the Position IDs or spatial metadata. In another embodiment, the manifests may be used by the device application to specify how to position each video, relative to the other videos contained within a 360 Video. In addition, in another embodiment, the manifest may include information concerning how to match the audio, produced in conjunction with the audio data feeds, with the 360 video.

In another exemplary embodiment of the present disclosure and with reference to FIG. 1, in step 80, the video and audio streams are consumed by a playback device. In one embodiment, the video files are transmitted over one or more networks. In such an embodiment, a playback device downloads the video files over the one or more networks. In another embodiment, the playback device may optimize the bandwidth by prioritizing the files when downloading. In one embodiment, the playback device may download the video files used to create the current field of view in the highest possible resolution. In such an embodiment, the playback device may download the other video files in a lower resolution. Alternatively, the playback device may not download any other videos than those required to create the current field of view.

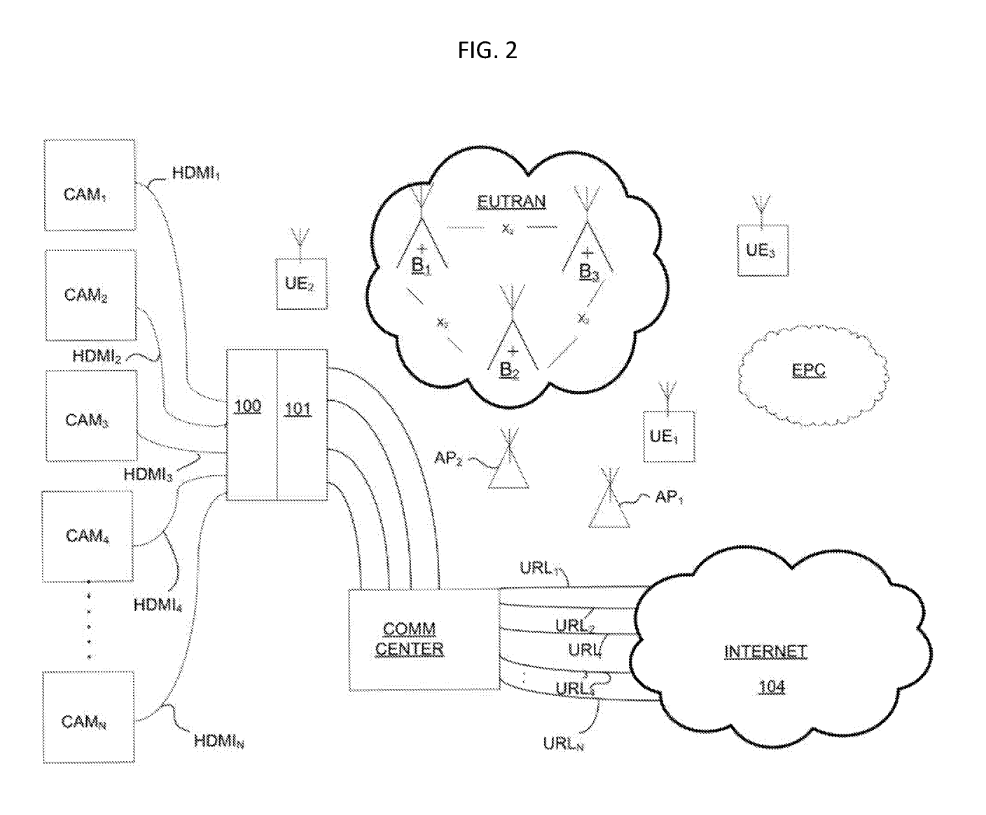

FIG. 2 is a diagram illustrating yet another exemplary embodiment of the present disclosure. Cameras, Cam1 through Cam n, (n being an integer) provide feeds to Data Prep 100. Data Prep 100 stitches video/audio and subsequently cuts and separates the video and audio prior to encoding, by Encoder 101. Encoder 101 encodes separated video and audio with metadata of the type describe above to facilitate re-stitching. Consequently, metadata, such as spatial metadata, Position IDs created from spatial metadata, manifests, etc. are encoded with the video in a chosen format such as H.264 (i.e., MPEG-4/AVC). The output from Encoder 101 may be sent to a communication center 102 which streams the encoded video/audio according to one or more uniform resource locator (URL) addresses. The encoded video/audio may be dispatched using a wide area network (WAN). Alternatively or in addition thereto, the encoded video/audio may be dispatched using WiFi or Bluetooth™ in connection with data being streamed from through one or more URLs from one or more access points APₙ (n being a positive integer) from one or more network. The URL streams, which may correspond to a particular camera position, view, may be routed through the Internet 104. Alternatively or in addition, Communication (Comm) Center 102 may interact wirelessly with a radio access network, such as a EUTRAN (Evolved Universal Terrestrial Radio Access Network) network (although other networks are contemplated such as 3G, etc. are contemplated) having one or more eNode Bs (shown in FIG. 2 as B₁, B₂ and B₃) connected by a X2 interface (shown as X₂, which may communicate with one or more user equipment (e.g., mobile phone, mobile tablet, etc,) devices denote by UEₙ, n being a positive integer.

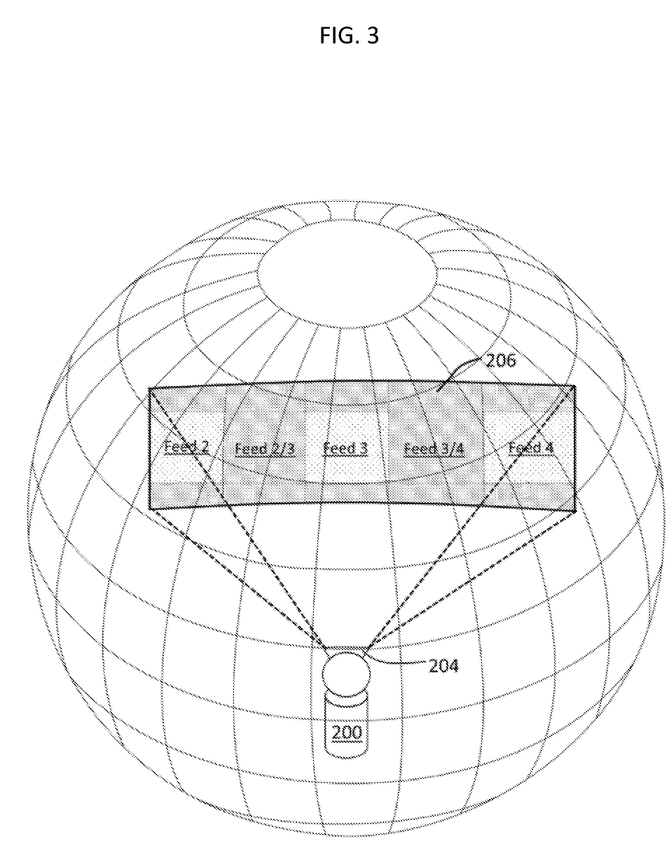

FIG. 3 is a diagram illustrating playback of video/audio according to some embodiments herein. FIG. 3 shows user 200 wearing a video/audio headset 202, the device through which 360 Video/audio is seen/heard. Video headset 202 is connected to controller 204 which contains hardware/software for controlling the presentation of video/audio to user 200. The combination shown of user 200, video/audio headset 202 and controller 204 may be representative of UE₁. Each UE is capable of receiving video/audio from one or more feeds representing data streamed from respective URLs (shown as URL_{N}, (N being a positive integer). For instance, FIG. 3 shows video/audio perspective 206 presented by video/audio headset 202 in connection with the orientation of video/audio headset 202. Video/audio headset 202, in connection with controller 204, is presented with a video/audio reception perspective dependent on the position of video/audio headset 202 (also denoted headset 202). Perspective 206 may, for instance, present user 200 with video and audio compiled from three cameras/ microphones streamed from feeds from 3 separate URLs so as to present video covering, for instance, a less than 180° field of view along with the respective audio corresponding to that field of view (out of a possible 360° spherical field of view). For instance, a microphone with a specified directionality/polar pattern (cardioid, omnidirectional, supercardioid, etc.) may be present with the camera contributing to a view. As shown in FIG. 3, Feed 2, Feed 3 and Feed 4 are presented to user 200 in connection with the particular orientation of headset 202 as shown. F2/3 represents video/audio stitched from the combination of content from Feed 2 and Feed 3. F3/4 represents video/audio stitched from the combination of content from Feed 3 and Feed 4. Different feeds from different cameras may be presented to user 200 in connection with different headset orientations. In any case, the feeds from multiple URLs/bitstreams permits more options for video and audio reception as compared with receipt of video/audio streamed from a single URL. For instance, video/audio from Feed 3, corresponding to video/audio streamed from URL₃, may be presented at a higher bit rate given considerations which include that the presentation is directly in front of a user's field of vision/hearing.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for providing 360 video comprising:
a video encoder for encoding video data with metadata including a manifest; and
communication means for transmitting a plurality of video data feeds from the video encoder, each video data feed being streamed over one or more uniform resource locators (URLs), the plurality of video data feeds being capable of being decoded according to the metadata to produce spherical video, the manifest carrying information on how to position video produced from the plurality of video data feeds.

2. The system as recited in claim 1 which further comprises:
an audio encoder for encoding audio data with spatial metadata; and
a plurality of audio data feeds from the audio encoder, each audio data feed being streamed over one or more uniform resource locators (URLs), the plurality of audio data feeds being capable of being decoded according to the metadata.

3. The system as recited in claim 2 wherein the spatial metadata includes information describing the direction of at least one microphone that has captured the audio data.

4. The system as recited in claim 2 wherein a separate stereo audio track is created corresponding to a separate video.

5. The system as recited in claim 1 wherein at least one video data feed is streamed according to an adaptive bit rate (ABR).

6. The system as recited in claim 1 wherein the metadata includes one or more position IDs.

7. An apparatus for receiving 360 video comprising:
a headset for viewing video;
a controller for coordinating video views with headset movement, said controller including a decoder, the controller being operable to receive streamed video data feeds from a plurality of URLs and the decoder being operable to decode metadata contained within the streamed video data feeds to enable the headset to produce 360 video from stitched together video.

8. The apparatus as recited in claim 7 wherein the headset includes one or more audio speakers for hearing audio produced from audio data.

9. The apparatus as recited in claim 8 wherein a separate stereo audio track is created corresponding to a separate video.

10. The apparatus as recited in claim 8 wherein the metadata includes spatial metadata which includes information describing the direction of at least one microphone that has captured the audio data.

11. The apparatus as recited in claim 7 wherein the metadata includes one or more position IDs.

12. The apparatus as recited in claim 7 wherein the metadata includes a manifest carrying information on how to position video produced from the plurality of video data feeds.

13. The apparatus as recited in claim 7 wherein at least one video data feed is streamed according to an adaptive bit rate (ABR) wherein video data is streamed higher for views within the headset field of view.

14. A method of transmitting 360 video comprising:
receiving video data from a plurality of cameras;
determining spherical video with the video data from the plurality of cameras;
documenting the spherical video by creating metadata including a manifest carrying information on how to position video produced from a plurality of video data feeds resulting from the video data from the plurality of cameras;
streaming the plurality of video data feeds including the metadata for reconstruction of the spherical video.

15. The method as recited in claim 14 wherein the metadata includes one or more position IDs.

16. The method as recited in claim 14 further comprising:
receiving audio data from a plurality of microphones;
producing a plurality of audio data feeds from the audio data; and
streaming a plurality of audio data feeds from a plurality of URLs, the audio data feeds including metadata.

17. The method as recited in claim 16 wherein the metadata includes spatial metadata having information describing the direction of at least one microphone which has captured the audio data.

18. The method as recited in claim 14 wherein a separate stereo audio track is created corresponding to a separate video.

19. The method as recited in claim 14 wherein streaming the plurality of video data feeds is accomplished according to an adaptive bit rate (ABR).

20. The method as recited in claim 14 wherein receiving the video data is accomplished through one or more HDMI inputs.
